(19) United States
(12) Patent Application Publication
(10) Pub. No.: US 2024/0394450 A1
(43) Pub. Date: Nov. 28, 2024

(54) INDEPENDENT EMULATION OF SEPARATE PORTIONS OF INTEGRATED CIRCUIT DESIGN

(71) Applicant: Synopsys, Inc., Sunnyvale, CA (US)

(72) Inventors: Cedric Jean Alquier, Wissous (FR); Jean-Philippe Colrat, Wissous (FR); Luc François Vidal, Villemoisson-sur-Orge (FR); Mikhail Bershteyn, New York, NY (US)

(21) Appl. No.: 18/383,355

(22) Filed: Oct. 24, 2023

Related U.S. Application Data
(60) Provisional application No. 63/469,239, filed on May 26, 2023.

(51) Int. Cl. G06F 30/347

(52) U.S. Cl. CPC G06F 30/347

(57) ABSTRACT

A method includes: receiving an integrated circuit design including a plurality of circuit modules; partitioning the integrated circuit design into a plurality of partitions in accordance with the plurality of circuit modules; assigning the plurality of partitions of the integrated circuit design to corresponding portions of an emulation system; inserting, by a processor, a plurality of emulation communication circuit structures into the plurality of circuit modules of the integrated circuit design, the corresponding portions of the emulation system being configured to communicate via one or more emulation interconnects connected to the emulation communication circuit structures, the emulation communication circuit structures being represented at a representation level selected from a group comprising: a packet level; a transaction level; and a protocol level; and emulating operation of the integrated circuit design using the emulation system.

### RELATED APPLICATION

This application claims priority to and the benefit of U.S. Provisional Patent Application No. 63/469,239 “INDEPENDENT EMULATION OF SEPARATE PORTIONS OF INTEGRATED CIRCUIT DESIGNS” filed in the United States Patent and Trademark Office on May 26, 2023, the entire content of which is incorporated by reference herein.

### TECHNICAL FIELD

The present disclosure relates to emulation of integrated circuit designs. In particular, the present disclosure relates to a system and method for partitioning an integrated circuit design and emulating the partitioned integrated circuit design on different components of an emulation environment.

### BACKGROUND

A design for an integrated circuit such as a system-on-chip (SoC) processor may include multiple circuit portions (intellectual property blocks or IP blocks) that communicate via on-chip interconnects (e.g., an electrical bus or a network-on-chip).

An emulation environment emulates the operation of an integrated circuit design to perform verification, such as testing that the integrated circuit design operates in accordance with specifications and satisfies requirements.

The above information disclosed in this Background section is only for enhancement of understanding of the present disclosure, and therefore it may contain information that does not form the prior art that is already known to a person of ordinary skill in the art.

### SUMMARY

According to one embodiment of the present disclosure, a method includes: receiving an integrated circuit design including a plurality of circuit modules; partitioning the integrated circuit design into a plurality of partitions in accordance with the plurality of circuit modules; assigning the plurality of partitions of the integrated circuit design to corresponding portions of an emulation system; inserting, by a processor, a plurality of emulation communication circuit structures into the plurality of circuit modules of the integrated circuit design, the corresponding portions of the emulation system being configured to communicate via one or more emulation interconnects connected to the emulation communication circuit structures, the emulation communication circuit structures being represented at a representation level selected from a group comprising: a packet level; a transaction level; and a protocol level; and emulating operation of the integrated circuit design using the emulation system.

The portions of the emulation system may include one or more components selected from a group comprising: a field programmable gate array; a board including a plurality of field programmable gate arrays; and a computer system connected to a plurality of boards of field programmable gate arrays.

The emulation interconnects may include one or more interconnects selected from a group comprising: a low-voltage differential signaling interconnect; a multi-gigabit transceiver; a backplane of an emulation unit; and an Ethernet connection.

The method may further include supplying the plurality of circuit modules separately to an emulation compiler to generate a plurality of compiled circuit modules.

The emulation compiler may be configured to compile an emulation communication circuit structure into a circuit module of the plurality of circuit modules, the emulation communication circuit structure being configured to communicate with another circuit module of the plurality of circuit modules via the one or more emulation interconnects.

The method may further include: capturing stimuli transmitted from a first partition of the plurality of partitions to a second partition of the plurality of partitions over the one or more emulation interconnects during emulation of the operation of the first partition and the second partition of the integrated circuit design; and storing the stimuli as a plurality of captured stimuli in a stimuli store, a captured stimulus of the captured stimuli including an emulation timestamp based on an emulation clock of the emulation of the second partition.

The method may further include: configuring a portion of the emulation system to emulate the second partition; and supplying the captured stimuli from the stimuli store to the second partition during emulation of the operation of the second partition using the emulation system without emulating the first partition.

The emulating the operation of the integrated circuit design using the emulation system may include: emulating a first partition of the plurality of partitions including a first circuit module of the plurality of circuit modules using a first portion of the emulation system in accordance with a first emulation clock; and emulating a second partition of the plurality of partitions including a second circuit module of the plurality of circuit modules using a second portion of the emulation system in accordance with a second emulation clock, the second emulation clock being independent of the first emulation clock.

According to one embodiment of the present disclosure, a system includes: a first emulation system including a first plurality of field programmable gate arrays (FPGAs); a second emulation system including one or more second plurality of FPGAs; and a host system including a processor and memory storing instructions that, when executed, cause the processor to: receive an integrated circuit design including a plurality of circuit modules configured to communicate via a latency tolerant interconnect; partition the integrated circuit design into a plurality of partitions in accordance with the plurality of circuit modules; insert a first emulation communication circuit structure into a first FPGA of the first plurality of FPGAs and a second emulation communication circuit structure into a second FPGA of the second plurality of FPGAs, the first emulation communication circuit structure and the second emulation communication circuit structure being represented at a representation level selected from a group comprising: a packet level; a transaction level; and a protocol level; configure the first plurality of FPGAs of the first emulation system to emulate a first partition of the plurality of partitions of the integrated circuit design; configure the second plurality of FPGAs of the second emulation system to emulate a second partition of the plurality of partitions of the integrated circuit design; and emulate operation of the integrated circuit design using the first emulation system and the second emulation system, the first partition and the second partition being configured to communicate using the first emulation communication circuit structure and the second emulation communication circuit structure.

The memory may further store instructions that, when executed, cause the processor to control a stimuli capture circuit to capture stimuli transmitted from the first partition emulated by the first emulation system to the second partition emulated by the second emulation system.

The stimuli capture circuit may be connected to an emulation interconnect between the first emulation system and the second emulation system.

The stimuli capture circuit may be connected to an emulation communication circuit structure of the second emulation system.

The first emulation system may be configured to emulate the first partition at a first emulation clock rate, and the second emulation system may be configured to emulate the second partition at a second emulation clock rate independent of the first emulation clock rate.

According to one embodiment of the present disclosure, a non-transitory computer-readable medium includes stored instructions, which when executed by a processor cause the processor to: receive an integrated circuit design including a plurality of circuit modules configured to communicate via a latency tolerant interconnect; partition the integrated circuit design into a plurality of partitions in accordance with the circuit modules; insert a first emulation communication circuit structure into a first circuit module of a first partition of the plurality of partitions, the first emulation communication circuit structure being represented at a first representation level selected from a group comprising: a packet level; a transaction level; and a protocol level; compile the first circuit module to generate a first compiled circuit module including a first bitfile to configure a first field programmable gate array (FPGA) to emulate a first portion of the first circuit module; insert a second emulation communication circuit structure into a second circuit module of a second partition of the plurality of partitions, the second emulation communication circuit structure being represented at a second representation level selected from the group comprising: the packet level; the transaction level; and the protocol level; and compile the second circuit module, independent of the first circuit module, to generate a second compiled circuit module including a second bitfile to configure a second FPGA to emulate a second portion of the second circuit module.

The first emulation communication circuit structure may be connected to an output pin of the first circuit module and is configured to send a packet of data representing a signal at the output pin in accordance with a protocol, and the second emulation communication circuit structure may be connected to an input pin of the second circuit module and is configured to receive the packet of data in accordance with the protocol and to supply the signal represented in the packet of data to the input pin.

The first emulation communication circuit structure and the second emulation communication circuit structure may be represented at the protocol level.

The first emulation communication circuit structure and the second emulation communication circuit structure may be represented at the transaction level.

The first emulation communication circuit structure and the second emulation communication circuit structure may be represented at the packet level.

The non-transitory computer-readable medium may further store instructions that, when executed, cause the processor to: receive an updated integrated circuit design, wherein the first circuit module in the updated integrated circuit design is replaced with an updated first circuit module and wherein the second circuit module is unchanged from the second circuit module of the integrated circuit design; and compile the updated first circuit module to generate an updated first compiled circuit module including a first updated bitfile to configure the first FPGA to emulate a first portion of the updated first circuit module without recompiling the second circuit module.

The first compiled circuit module may be controlled by a first emulation clock, and the second compiled circuit module may be controlled by a second emulation clock independent of the first emulation clock.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a block diagram depicting the compilation of separate circuit modules or IP blocks by an emulation compiler, according to one embodiment of the present disclosure.

FIG. 2 is a flowchart of a method for emulating an integrated circuit design, according to one embodiment of the present disclosure.

FIG. 3A is a block diagram illustrating a stimuli capture and replay mechanism, according to one embodiment of the present disclosure.

FIG. 3B is a block diagram illustrating another stimuli capture and replay mechanism according to one embodiment of the present disclosure.

FIG. 4 is a flowchart of a method for compiling partitions of an integrated circuit design separately and inserting emulation communication circuit structures, according to one embodiment of the present disclosure.

FIG. 5 depicts a layered view of the connection for emulation communication between two circuit modules or IP blocks, where the connection is implemented using three layers of representation, according to one embodiment of the present disclosure.

FIG. 6 is a block diagram illustrating a send circuit and a receive circuit inserted by an emulation compiler, according to one embodiment of the present disclosure.

FIG. 7 is a flowchart of a method for running a partitioned emulation of an integrated circuit design, according to one embodiment of the present disclosure.

FIG. 8 is a flowchart of a method for emulating a subset of the partitions of an integrated circuit design using a replay of stimuli from other partitions, according to one embodiment of the present disclosure.

FIG. 9 depicts a flowchart of various processes used during the design and manufacture of an integrated circuit, in accordance with some embodiments of the present disclosure.

FIG. 10 depicts a diagram of an example emulation system in an emulation environment, in accordance with some embodiments of the present disclosure.

FIG. 11 depicts a diagram of an example computer system in which embodiments of the present disclosure may operate.

### DETAILED DESCRIPTION

Aspects of the present disclosure relate to independent emulation of separate portions of an integrated circuit design.

An emulation environment or integrated circuit emulator is a hardware system that is configured to emulate the operation of an integrated circuit design by implementing the components of the integrated circuit design using reconfigurable hardware such as one or more field programmable gate arrays (FPGAs). (In contrast, a simulator for an integrated software represents the components of a given integrated circuit design in a memory of a computer system where one or more processors simulate the operation of the components represented in the memory by updating the electrical states of connections between the components as represented in the memory.)

An emulation system may include multiple field-programmable gate array (FPGA) integrated circuits that are interconnected using technologies such as multi-gigabit transceivers (MGT), low-voltage differential signaling (LVDS), and the like (e.g., other high-throughput interconnects). Connections between FPGAs can be fixed or they can be established by programmable switches, which allow improved flexibility in communications between the FPGAs. In some examples of emulation systems, multiple FPGAs are mounted on a printed circuit board (PCB) and may communicate with one another through emulation system interconnects (or emulation interconnects) that may include electrical traces on the PCB. The printed circuit board (or board) may be connected to a backplane (e.g., as an expansion card of a computer system) and may therefore communicate with FPGAs mounted on other PCBs and/or a central processing unit (CPU) of a host computer system controlling the emulation system through other emulation system interconnects that may be implemented using interconnect technologies (e.g., Peripheral Component Interconnect Express or PCIe or the like). An emulation environment may include multiple emulation systems, each emulation system including one or more FPGAs mounted on one or more printed circuit boards, where the multiple emulation systems may communicate via external cables and, in some cases, switches, routers, or hubs, and using communications protocols such as Universal Serial Bus (USB), External PCI Express (ePCIe), Thunderbolt, and computer network protocols (e.g., Ethernet). This hierarchical arrangement of FPGAs in an emulation environment means that communicating between FPGAs may encounter different amounts of latency (e.g., delay between sending a message and receiving a message) and bandwidth (the amount of data that can be transferred per unit time) depending on the relative locations of those communicating FPGAs, such as whether the FPGAs are on the same PCB, on different PCBs connected to the same backplane, connected to different backplanes, or in different computer systems corresponding to different emulation systems.

An integrated circuit design that is to be emulated by an emulation environment may include multiple circuit portions or circuit modules, which may be referred to as intellectual property blocks (IPs). The separate circuit portions or circuit modules may communicate over an on-chip interconnect (such as a network-on-chip or NoC) using communication protocols such as Universal Chiplet Interconnect Express (UCIe), PCIe, or proprietary communication protocols specific to the integrated circuit design. The on-chip interconnect may be referred to as a latency tolerant interconnect and the communications may be referred to as being latency tolerant communications as the communications between the circuit portions may be performed asynchronously. Data may be exchanged between the circuit portions or circuit modules in units of packets. In the case of a network-on-chip, an on-chip router may perform packet switching to transmit the packets of data through the NoC from a transmitting circuit portion to a receiving circuit portion. In a physical implementation of the integrated circuit design, the communications between the circuit portions of the integrated circuit design would take place entirely within a same semiconductor die.

During the design and verification of such an integrated circuit design, the design can be compiled by an emulation compiler and emulated in an emulation environment. The emulation compiler converts a representation of the integrated circuit design (e.g., starting from a high-level representation in a hardware description language (HDL), a logic-level register transfer level or RTL description, or a gate-level description in the form of a netlist) into one or more bitfiles for configuring the FPGAs of the emulation environment and information for controlling communications between the FPGAs of the emulation environment (e.g., for generating emulation clock signals).

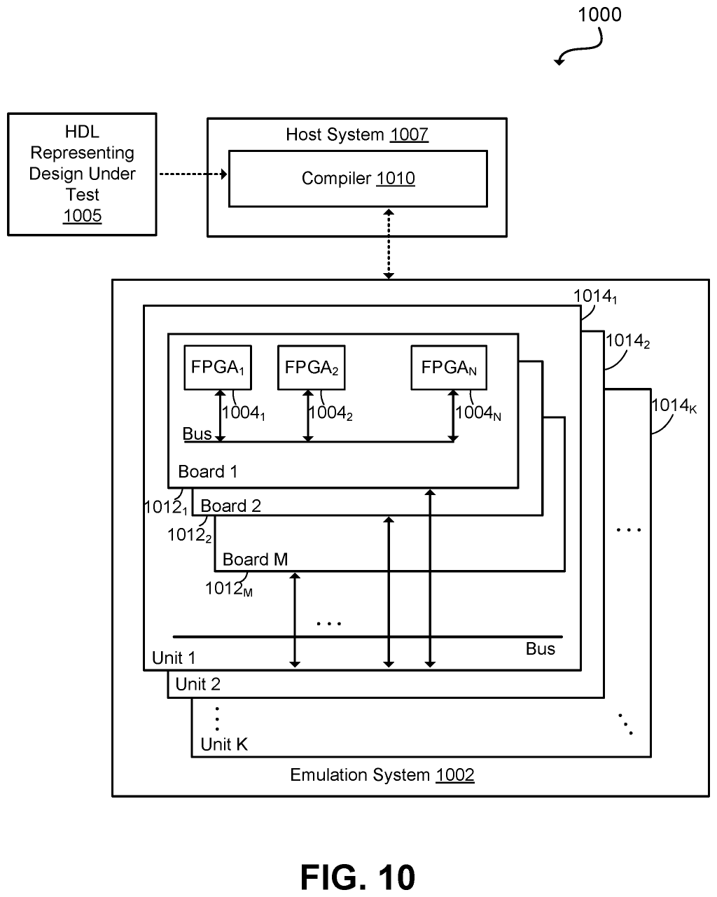

However, when compiling a complex design that includes multiple circuit portions (multiple IPs) that communicate over a latency tolerant interconnect, several inefficiencies can be observed. Some of these inefficiencies relate to runtime performance limitations. The maximum achievable performance is approximately inversely proportional to design size because emulation must be synchronized across all FPGAs and such synchronization requires time. If one circuit portion (e.g., one IP block) of the design needs to perform time-consuming operations (such as interactions with the computer system running the emulation software, such as host system 1007 shown in FIG. 10) then the emulation clock is stopped for all circuit portions of the entire integrated circuit design, thereby preventing execution of the emulation of the remaining portion of the integrated circuit design. The longest timing path of any circuit portion limits the emulation speed for the entire design because the design must be emulated in time-synchronous manner. Frequently, a timing path between the circuit portions becomes critical limiter of emulation speed, especially when emulation interconnections between portions of the emulation hardware is implemented with high latency interconnects such as multi-gigabit transceivers (MGT), which may include emulation delays along that timing path on the order of hundreds of nanoseconds (bandwidth limitations on the communication busses connecting these different parts of the emulation environment may also introduce delays as the signals are queue for transmission). Therefore, these emulation communications over long timing paths of the integrated circuit design that extend between portions of the emulation hardware limits the maximum emulation clock speed any given circuit portion (or IP block), because the emulation must be performed in a time-synchronous manner. Sharing an emulation clock across all the circuit portions of the integrated circuit design forces the emulations of the other portions of the integrated circuit design to also operate at the clock rate imposed by the circuit portion or IP block that has the slowest emulation clock rate. This applies even if the integrated circuit design specifies that different portions of the integrated circuit design operate in different clock domains (e.g., are controlled by different internal clocks or user clocks), because those different clock domains are ultimately controlled by a same emulation clock.

Additional inefficiencies may arise with respect to compilation of the design for the emulation environment. During the course of the design process, emulation may reveal errors (bugs) in the design that cause the design to behave in a manner inconsistent with the specifications for the integrated circuit design. During debugging, one or more circuit portions (circuit modules or IP modules) of the design may be modified to attempt to correct the bug, but an emulation compiler must recompile the entire design, including circuit portions that were not modified. This results in an increase in computing resources and long compile times that may be redundant because they force recompiling portions of the design that were unchanged. Furthermore, if several circuit portions (circuit modules or IPs) are identical, compilation resources and time are proportional to number of IPs instantiated in the design (e.g., each copy of the circuit portion is compiled separately), rather than reusing the previously compiled portion. (For example, a single design of an integrated circuit may include multiple identical computing cores that communicate over a latency tolerant interconnect.)

Further inefficiencies may relate to emulation cost of ownership. Debugging a particular circuit module usually requires the complete integrated circuit design to be emulated, including circuit modules that are loosely connected to the circuit module of interest that is being debugged. This causes more emulation hardware resources (e.g., FPGAs) to be used for debugging this single portion of the overall design, where those emulation hardware resources could be used for emulating other integrated circuit designs (e.g., by other users emulating other projects). This increases overall cost of ownership of emulation environments or integrated circuit emulators on organizations that design integrated circuits. To emulate a large design the user needs to acquire correspondingly large, monolithic emulation environment. Several smaller emulation environments of the overall equivalent capacity cannot be easily adapted to this purpose.

Accordingly, aspects of embodiments of the present disclosure relate to overcoming the above listed limitations. Some aspects of the present disclosure relate to splitting (or partitioning) a given integrated circuit design into several partitions or circuit portions and compiling each partition or circuit portion or circuit module as a stand-alone design. These separate compiled designs are then loaded into different parts of an emulation system (e.g., dedicating a single board of multiple FPGAs to one of the circuit modules) or in an emulation environment including several independent emulation host systems (e.g., spreading the circuit modules across multiple host computer systems, each such host computer system being directly connected to one or more FPGAs configured to emulate corresponding parts of the compiled designs), where one aspect of independence relates to each independent emulation system uses a separate emulation clock. Emulation systems or parts of a single system are interconnected by communication channels such as LVDS or MGT. Such links are used to establish an asynchronous communication between the emulated designs.

Technical advantages of the present disclosure include, but are not limited to reducing the cost of ownership with respect to debugging or isolating potential errors in a design by emulating the separate parts or IP blocks of an integrated circuit designs using separate emulation systems. This also provides a technical advantage of being able to debug a single IP block or module of an integrated circuit design that includes multiple IP blocks in isolation by recording the incoming stimuli from other IP blocks (during a prior emulation of the full integrated circuit design) and replaying the incoming stimuli according to some embodiments of the present disclosure. Emulating only a single IP block (or a subset of the IP blocks) of an integrated circuit design in compares favorably to emulating the full integrated circuit design when debugging only the single IP block (or subset of IP blocks) because fewer emulation resources (e.g., fewer FPGAs) are needed to perform the emulation, thereby freeing emulation resources for use on other integrated circuit designs (e.g., thereby reducing the cost of emulation during the process of developing the integrated circuit design) and also enabling the emulation of the single IP block to be performed without being held back by the synchronous emulation of other IP blocks that may need to be emulated at lower speeds for reasons discussed above (e.g., timing paths extending between FPGAs). Furthermore, the asynchronous communication between emulation systems with each emulation system being able to run at its maximum possible speed allows the emulation of the integrated circuit design to complete in a shorter amount of time.

For example, some aspects of the present disclosure relate to partitioning the full integrated circuit design at the boundaries in which the different circuit modules would communicate through the latency tolerant interconnects in the design, such that the latency tolerant communications between those circuit modules of the emulated design are performed over the corresponding higher latency emulation interconnects of the emulation environment. Accordingly, embodiments of the present disclosure relate to decoupling the circuit portions of the full design for emulation on separate parts of the emulation environment, where the decoupling is performed based on the underlying decoupled design of the integrated circuit. Aspects of embodiments of the present disclosure further relate to interfaces between the circuit modules that make up the overall design and providing multiple levels of representation for these interfaces.

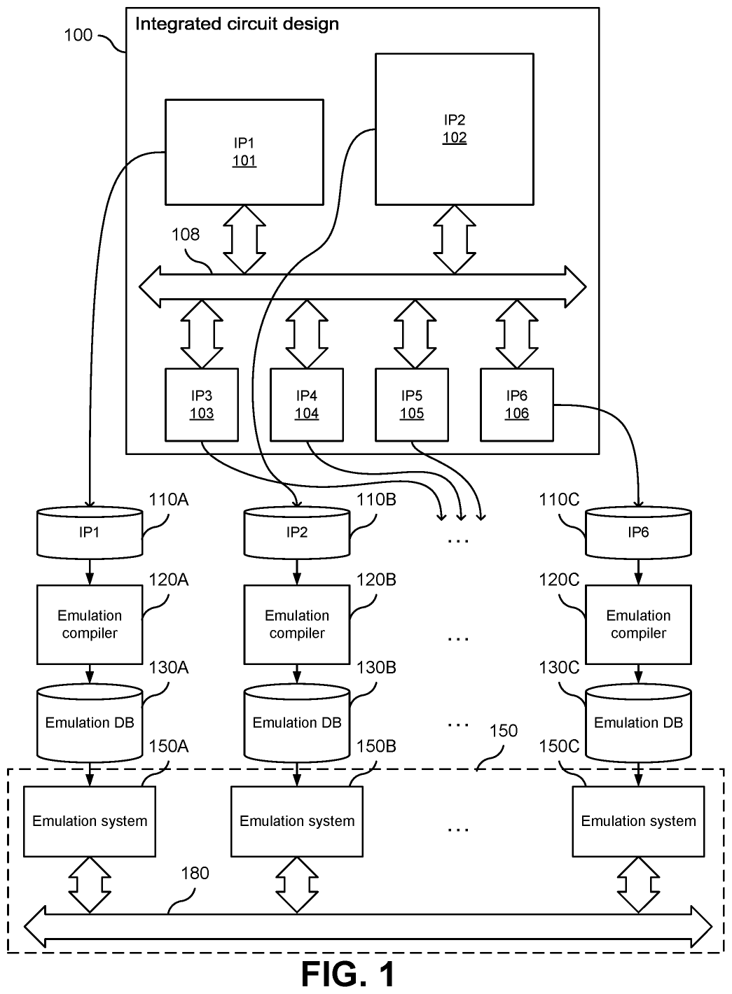

FIG. 1 is a block diagram depicting the compilation of separate circuit modules or IP blocks by an emulation compiler according to one embodiment of the present disclosure. As shown in FIG. 1, a given integrated circuit design 100 may include multiple circuit modules or IP blocks, labeled IP1 101, IP2 102, IP3 103, IP4 104, IP5 105, and IP6 106. The different circuit modules IP1 though IP6 communicate through an on-chip latency tolerant interconnect 108 (e.g., a network on chip or the like). For example, the circuit modules may include transmit buffers and receive buffers (or first-in-first out or FIFO memories) to store packets of data to be transmitted to other circuit modules or packets of data that are received asynchronously from other circuit modules.

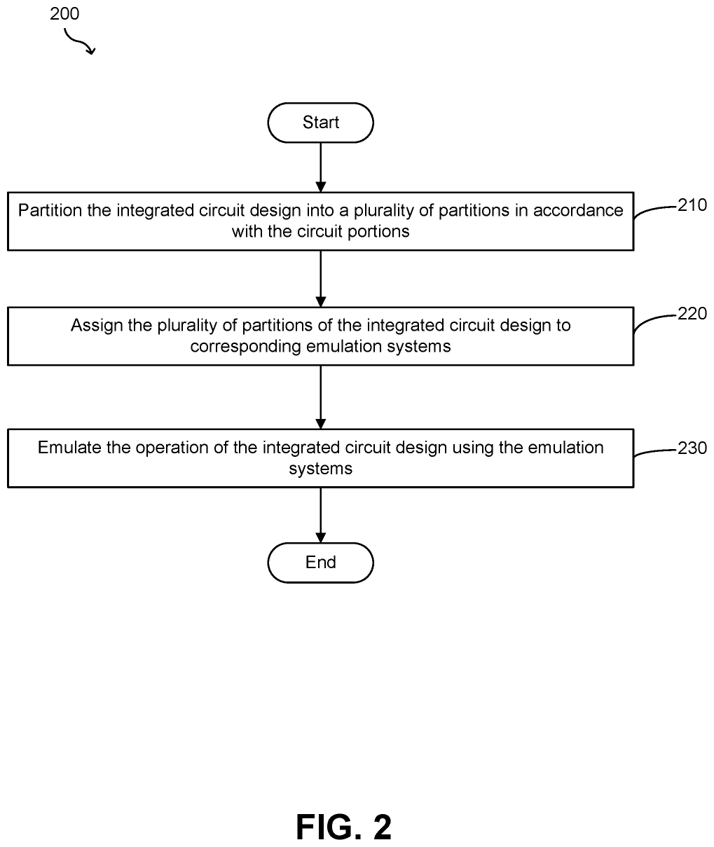

FIG. 2 is a flowchart of a method 200 for emulating an integrated circuit design according to one embodiment of the present disclosure.

Some aspects of embodiments relate to partitioning an integrated circuit design into multiple partitions in accordance with the communication boundaries of the circuit modules at 210 of FIG. 2. As noted above, the different circuit modules IP1 through IP6 of the integrated circuit design 100 of FIG. 1 communicate through an on-chip latency tolerant interconnect 108 and therefore the full integrated circuit design 100 can be partitioned such that circuit modules that communicate through the on-chip latency tolerant interconnect 108 are in different partitions and portions of the integrated circuit design that communicate directly with each other (e.g., portions of the circuit that contain combinational elements that connect through direct wiring and not through a bus or shared interconnect) are in a same partition. These partitions may correspond to the separate IP blocks or circuit modules of the integrated circuit design. For example, each partition may have exactly one or more IP blocks or circuit modules.

The digital representations 110 of the separate circuit modules or IP blocks (e.g., as expressed in a hardware description language, logic-level register transfer level description, or a netlist), shown as 110A for circuit module IP1 101, 110B for circuit module IP2 102, and 110C for circuit module IP6 106, are then compiled by an emulation compiler 120 (shown as separate emulation compilers 120A, 120B, and 120C to indicate that the compilation process can be performed for the separate digital representations 110A, 110B, and 110C in parallel) into a plurality of bitfiles or other digital representations of the integrated circuit design for configuring an emulation system (e.g., for configuring one or more FPGAs of the emulation system). The compiled data may be stored in a persistent store 130 for later reuse (e.g., an emulation database or emulation DB), shown as separate emulation DBs 130A, 130B, and 130C to indicate that they may be stored in different databases or in the same database. The compiled data can then be retrieved from the emulation DB (or emulation DBs) and assigned at 220 to configure one or more emulation systems making up an emulation environment 150 or components of emulation systems (e.g., individual FPGAs, boards of FPGAs, groups of boards of FPGAs, entire host computer systems and all of the FPGAs therein, and the like), shown as separate emulation systems 150A, 150B, and 150C to indicate that they may be implemented in the same emulation system or different emulation systems. The choice of the components of an emulation system 150 for a particular circuit module or IP block may depend on the size of the circuit module. An FPGA may be characterized by the number of programmable logic blocks contained therein which sets an upper limit on the number of circuit elements that can emulated using one such FPGA. Some circuit modules or IP blocks may have too many circuit elements to be emulated using a single FPGA and therefore multiple FPGAs of the emulation system may be used to emulate such a circuit module. Communication between FPGAs is performed over a communication link 180 (e.g., multi-gigabit transceivers, low voltage differential signaling, PCIe, Ethernet, combinations thereof, and the like) that introduce latency between portions implemented in different FPGAs. The latency increases as multiple levels of a hierarchical design of an emulation environment increases (e.g., latency increases when proceeding from single FPGA to other FPGAs on a same board, to other FPGAs in a same group of boards, to other FPGAs in different groups, or FPGAs connected to different host emulation systems). Accordingly, performance is improved by keeping an entire circuit module or IP block within the smallest component of the emulation system 150 that can emulate the entire circuit module or IP block.

As shown in FIG. 1, the designs 110A, 110B, and 110C for each circuit module or IP block are compiled independently by corresponding instances of the emulation compiler 120A, 120B, and 120C. After configuring the emulation system 150 and/or the separate components of the emulation system (e.g., 150A, 150B, and 150C) to emulate the different parts of the integrated circuit design 100, the emulation system 150 then emulates the operation of the integrated circuit block at 230. During emulation, various test input vectors may be supplied to the emulated integrated circuit design and the outputs and the operation of the emulated integrated circuit design can be captured and compared against expected results to verify whether the emulated integrated circuit design operates in accordance with its specifications.

In some embodiments, the emulation of each circuit module or IP block has independent emulation clock frequency and independent emulation clock stopping. Independent emulation clock frequencies allow the emulations of each circuit module by its corresponding emulation system (e.g., 150A, 150B, and 150C) to run at its maximum possible speed without limitation from the emulations of the other circuit modules. Independent emulation clock stopping allows a user to stop only local emulation of one of the circuit modules without impact on the emulations of the other circuit modules. Independent compilations allows recompilation of a single circuit module or IP block in case of an incremental change (e.g., a change only to circuit module IP6 106 without changing circuit module IP1 101 and circuit module IP2 102), thereby reducing computational resource consumption (e.g., avoiding recompiling portions of the full integrated circuit design 100 that have not changed).

Some aspects of embodiments of the present disclosure further relate to using a stimuli capture and replay mechanism at the level of single design. In more detail, a stimuli capture and replay mechanism according to some embodiments captures inputs to and outputs from a given circuit module (or multiple circuit modules) during the course of an emulation. These inputs may be transmitted to the circuit module from other circuit modules and the outputs from the circuit module may be provided to other circuit modules. When debugging errors associated with in a portion of the circuit design (e.g., only circuit modules IP3 and IP4 of the example full design shown in FIG. 1), it is not necessary to emulate the full design because the previously captured inputs from the other parts of the integrated circuit design (e.g., IP1, IP2, IP5, and IP6 of the example full design shown in FIG. 1) can be replayed or transmitted to circuit modules IP3 and IP4. This allows the debugging of IP3 and IP4 to be performed on a smaller emulation system (e.g., having fewer FPGAs), thereby freeing resources for use by other users and thereby reducing the overall cost of operating sufficient emulation systems to support the engineering efforts at the organization.

In order for the emulated circuit modules or IP blocks of the integrated circuit design to communicate across the different portions of the emulation system (e.g., across different boards, across different host computer systems, and the like), the emulation compiler inserts emulation communication circuit structures into the compiled design that, for example, configure the FPGA to connect portions of the circuit modules or IP blocks to input and output pins of the FPGAs, which, in turn, may be connected to router circuits for routing the messages between FPGAs (e.g., across boards of FPGAs and/or across host computer systems) through one or more emulation interconnects. The configuration of such inserted emulation communication circuit structures depends highly on how the compiled designs for the different circuit modules or IP blocks are instantiated in the emulation system (e.g., which IP blocks are located where in the overall emulation system). Accordingly, in some embodiments, the structures are configured as parameterizable modules that can be configured with parameters when loaded into the emulation system to configure the connections between the emulated circuit modules or IP blocks.

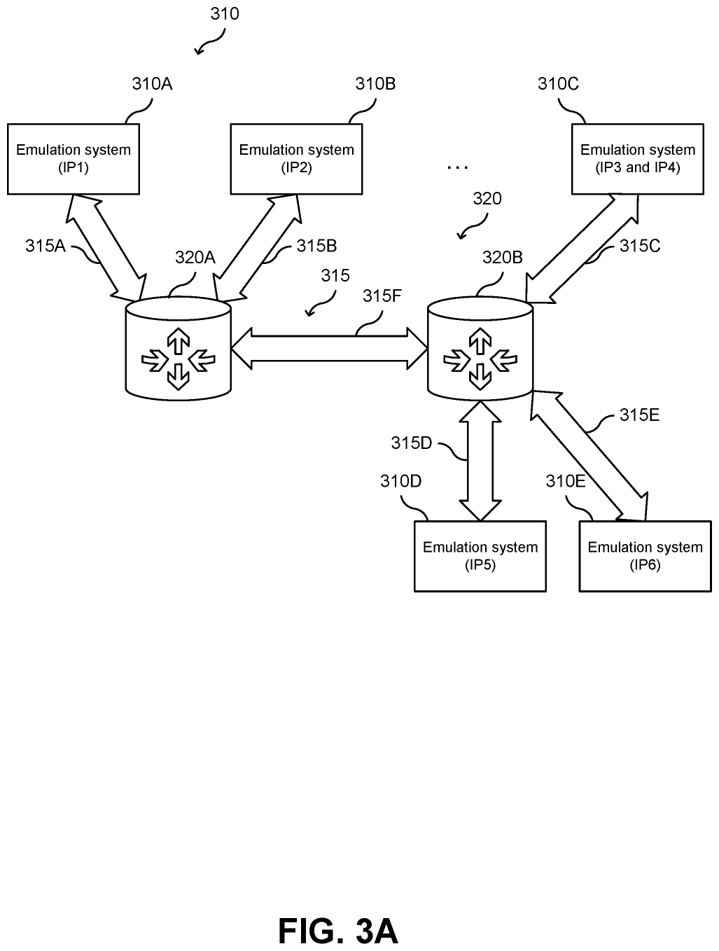

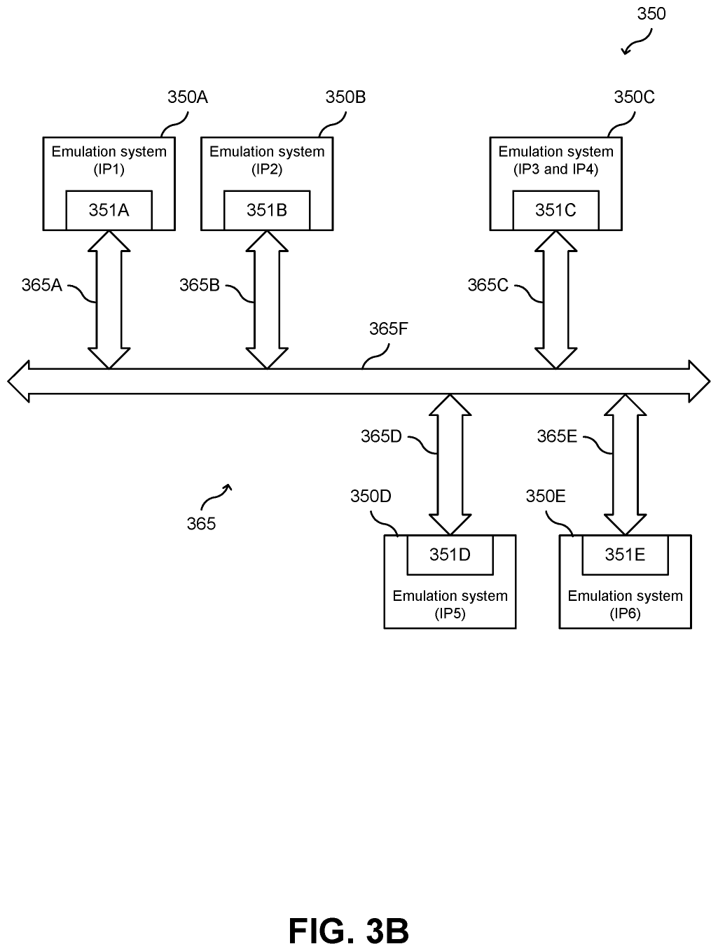

FIG. 3A is a block diagram illustrating a stimuli capture and replay mechanism according to one embodiment of the present disclosure. In the example shown in FIG. 3A, stimuli are transmitted between the partitions emulated by different emulation systems 310 (or different portions of an emulation system) through communication links 315 (e.g., corresponding to communication links 180 shown in FIG. 1), where one or more stimuli capture circuits 320 are connected to the communication links 315. In the example of FIG. 3A, a first emulation system 310A may be a full computer system that emulates first circuit module IP1 (e.g., because this circuit module may be large). Likewise, a second emulation system 310B may be a full computer system that emulates second circuit module IP2. Because the first emulation system 310A and the second emulation system 320B are full computer systems, they may communicate over communications links 315A and 315B, respectively, that are appropriate for computer systems communicating with outside devices, such as Ethernet. A first stimuli capture circuit 320A may be connected to communications links 315A and 315B to automatically capture stimuli from other emulation systems that are transmitted to the first emulation system 310A and the second emulation system 310B. Continuing the example where communications links 315A and 315B are Ethernet communication links (or other computer network links) these stimuli may be included in the payloads of network packets such as transmission control protocol/internet protocol (TCP/IP) packets. The first stimuli capture circuit 320A may include a stimuli store (e.g., dynamic random-access memory and/or persistent memory such as flash memory or a disk drive) to store the captured stimuli. In some embodiments, the captured stimuli are timestamped with the emulation clock cycle at which it is presented to a receiving circuit module based on the emulation clock of the emulation system emulating the receiving circuit module.

Similarly, as shown in FIG. 3A, a third emulation system 310C may be configured to emulate third circuit module IP3 and fourth circuit module IP4 of the full integrated circuit design. Likewise, a fourth emulation system 310D may be configured to emulate a fifth circuit module IP5, and a fifth emulation system 310E may be configured to emulate a sixth circuit module IP6. The third, fourth, fifth, and sixth circuit modules may be sufficiently small that they can all be emulated on a same computer system, where the corresponding emulation systems may be, for example, single PCBs, each PCB including multiple FPGAs. For example, third emulation system 310C may correspond to a first PCB, fourth emulation system 310D may correspond to a second PCB, and fifth emulation system 310E may correspond to a third PCB. The third emulation system 310C, fourth emulation system 310D, and fifth emulation system 310E may communicate over corresponding communication links, including third communication link 315C, fourth communication link 315D, and fifth communication link 315E, where these communication links may be implemented using a technology appropriate communication between PCBs of a computer system such as PCIe. A second stimuli capture circuit 320B may be connected to the third communication link 315C, fourth communication link 315D, and fifth communication link 315E to capture stimuli transmitted to the third emulation system 310C, fourth emulation system 310D, and fifth emulation system 310E respectively. The second stimuli capture circuit 320B may also be connected to the first stimuli capture circuit 310A over a sixth communication link 315F to allow stimuli to be exchanged between the first emulation system 310A, the second emulation system 310B, the third emulation system 310C, the fourth emulation system 310D, and the fifth emulation system 310E. In some embodiments, the captured stimuli are timestamped with the emulation clock cycle at which it is presented to a receiving circuit module based on the emulation clock of the emulation system emulating the receiving circuit module.

FIG. 3B is a block diagram illustrating another stimuli capture and replay mechanism according to one embodiment of the present disclosure. In the embodiment shown in FIG. 3B, the stimuli capture and replay mechanism is implemented at the level of the individual emulation systems, such that incoming stimuli to a given emulation system are captured by corresponding stimuli capture circuits. For example, first emulation system 350A includes a first stimuli capture circuit 351A configured to capture stimuli received over first communication link 365A from other emulation systems emulating other partitions of the integrated circuit design. Likewise, second emulation system 350B includes a second stimuli capture circuit 351B configured to capture stimuli received over second communication link 365B, and third emulation system 350C includes a third stimuli capture circuit 351C configured to capture stimuli received over third communication link 365C. Fourth emulation system 350D includes a fourth stimuli capture circuit 351D configured to capture stimuli received over fourth communication link 365D, and fifth emulation system 350E includes a fifth stimuli capture circuit 351E configured to capture stimuli received over fifth communication link 365E. All these emulation systems may communicate with one another over other communication links such as sixth communication link 365F, which may include heterogenous communication links (e.g., a mix of PCIe, LVDS, and Ethernet links) depending on the levels at which the various emulation systems are implemented. Each of the stimuli capture circuits may include a stimuli store (e.g., dynamic random-access memory and/or persistent memory such as flash memory or a disk drive) to store the captured stimuli. In some embodiments, the captured stimuli are timestamped with the emulation clock cycle at which it is presented to a receiving circuit module based on the emulation clock of the emulation system emulating the receiving circuit module.

In some embodiments, the stimuli capture circuits are connected to, or included in, the router circuits configured to route messages between the FPGAs, such as in the examples illustrated with respect to FIG. 3A. In some embodiments, the stimuli capture circuits are connected to, or included in, the emulation communication circuit structures inserted by the compiler into the partitioned circuit modules.

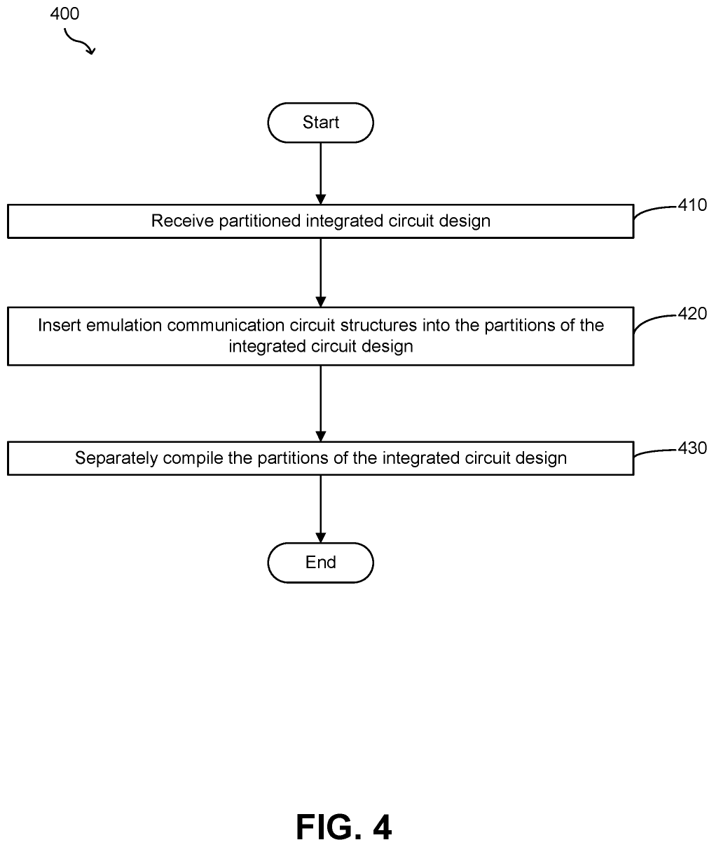

FIG. 4 is a flowchart of a method 400 for compiling partitions of an integrated circuit design separately and inserting emulation communication circuit structures according to one embodiment of the present disclosure. For example, the method 400 shown in FIG. 4 may be performed after partitioning the integrated circuit design into a plurality of partitions at 210 of the method 200 shown in FIG. 2 and before emulating the operation of the integrated circuit design at 230 (before or after assigning the plurality of partitions of the integrated circuit design to corresponding portions of an emulation system at 220). At 410, a computer system receives a partitioned integrated circuit design including a plurality of partitions. At 420, the computer system inserts emulation communication circuit structures into the partitions.

Some aspects of embodiments of the present disclosure relate to providing several levels of representation for users to define communication between any two IP blocks or circuit modules of the overall integrated circuit design. In some embodiments, the representations provide a layered model, from a more detailed level of representation (e.g., a lower-level model) to a less detailed level of representation (e.g., a higher-level model): packet level, transaction level and protocol level.

In some embodiments, a more detailed level of representation exposed to the user (e.g., an engineer designing the integrated circuit) is a packet level representation. At the packet level representation, a user can create a packet of bits to be sent from one IP block to another IP block of the integrated circuit design. Because this level of representation is close to the underlying representation of the signals, this may be referred to as a lower-level model. A parametrizable emulation communication circuit structure (or emulation communication circuit portion) according to some embodiments is provided to send data and another to receive data. These emulation communication circuit portions are inserted and connected in the user design. These emulation communication circuit portion support a simple handshake protocol to send and receive the packet. In some embodiments of this low-level representation, the user must also write (e.g., define) a controller circuit that can send or receive the data using the handshake protocol.

Following are examples of parametrizable emulation communication circuit portions used to communicate between emulators, as expressed in a hardware description language (HDL):

TABLE 1
emulation communication circuit portion
to send data to another emulator:

```
module zceiMessageOutPort(tx_rdy, rx_rdy, data);
  parameter N = 32;
  input tx_rdy;
  output rx_rdy;
  input [N-1:0] data;
endmodule
```

TABLE 2
emulation communication circuit portion
to receive data from another emulator:

```
module zceiMessageInPort(tx_rdy, rx_rdy, data);
  parameter N = 32;
  output tx_rdy;
  input rx_rdy;
  output [N-1:0] data;
endmodule
```

These structures may be added to, for example, the HDL representations of the partitions of the integrated circuit design at 420.

In some embodiments, send and receive modules are paired such that both ends have the same data size. For sending (or receiving) data, protocol is following: If tx_rdy (or rx_rdy) are 1 at posedge of local emulator clock, data is valid and considered sent (or received). Because a local clock is being used on each side, communication is asynchronous. Some latency exists between the sending IP block and the receiving IP block but this latency does not directly limit the speed of operation of either IP, which, in some embodiments, are emulated on independent emulation clocks, as discussed above. Accordingly, embodiments of the present disclosure enable decoupling the emulation of two different IP blocks or circuit modules within an integrated circuit design through asynchronous communication, such that the speed at which one IP block is emulated does not limit the speed at which other IP blocks can be emulated.

Another level of representation for communication between IP blocks is a transaction level or function level of communication. At the transaction level of representation, a user can employ function calls to implement communications associated with transactions between IP blocks. If a function call is executed in one IP block where that function is defined in another IP block, the emulation compiler generates, at 430, structures in the compiled design of the IP blocks (the caller IP block and the callee IP block) to implement asynchronous communication of function arguments (e.g., transmitted from the caller IP block) and its return value (transmitted from the callee IP block). In such embodiments, the emulation compiler is configured to transform, at 430, user code based on functions into state machines using a packet level representation as described above. Using a transaction level representation frees the user from implementing low level details (such as a handshake protocol) compared to a situation where the user had implemented the communications using the packet level representation directly, because those low-level details are implemented by the emulation compiler (e.g., inserting code from a library to implement a handshake protocol), with a tradeoff of reduced user control over how those details are implemented. In some embodiments, the emulation complier supports functions and tasks as defined by a hardware description language (e.g., Verilog functions and Verilog tasks as defined in the System Verilog Direct Programming Interface or DPI standard). An import function defined in one IP block corresponds to an export function in another IP block. Similarly, an input argument of a function in one IP block may correspond an output argument in another IP.

For example, a first IP block may include the code, as represented in a HDL, to generate a corresponding emulation communication circuit structure:

```
import “DPI-C” function void transfer(input bit [31:0] arg1);
always @(posedge clk)
  if (cond)
    transfer(arg1);
```

A second IP block may include the following code, as represented in a HDL, to generate a corresponding emulation communication circuit structure:

export “DPI-C” function void transfer;
function void transfer(output bit [31:0] arg1);
begin
d1 = arg1;
end
endfunction

A call to import function transfer in the first IP block side will cause the execution of the exported function in the second IP block. The emulation compiler may therefore generate, at 420, the following corresponding code using a packet level interface based on the function calls in the code defining the first IP block and the second IP block.

In the first IP block, as represented in a HDL, to generate a corresponding emulation communication circuit structure:

```
zceiMessageOutPort #(32) IP1_transfer_out(
  .tx_rdy(arg1_ip1_tx_rdy),
  .rx_rdy(arg1_ip2_rx_rdy),
  .message(arg1_msg)
};
bit [1:0] state;
always @(posedge clk) begin
  arg1_ip1_tx_rdy = 0;
  case (state) begin
    IDLE:
      begin
        if (cond) begin
          state = SEND;
          arg1_ip1_tx_rdy = 1;
        end
      end
    SEND:
      begin
        if (arg1_ip2_rx_rdy)
          // message sent
          arg1_ip1_tx_rdy = 0;
          state = IDLE;
      end
  end
end
```

In the second IP block, as represented in a HDL, to generate a corresponding emulation communication circuit structure:

```
zceiMessageInPort #(32) IP2_transfer_in(
  .tx_rdy(arg1_ip1_tx_rdy),
  .rx_rdy(arg1_ip2_rx_rdy),
  .message(arg1_msg)
);
bit [1:0] state;
always @(posedge clk) begin
  arg1_ip2_rx_rdy = 1;
  if (arg1_ip1_tx_rdy) begin
    d1 = arg1;
  end
end
```

A third level of representation according to some embodiments of the present disclosure relates to a protocol level of representation. At the protocol level, an interface is provided to the user to design the IP block or circuit module to a bit level interface in accordance with a custom or standard protocol interface (e.g., the Peripheral Component Interconnect Express or PCIe interface). In some embodiments, the emulation compiler compiles, at 430, the protocol level use of the defined interface to a packet level representation (e.g., implemented using previously defined DPI functions to transfer and receive data to and from the other IP blocks).

As noted above with respect to FIG. 1, the separate partitions of the integrated circuit design are compiled separately or independently at 430 into separate compiled data (e.g., separate bitfiles to configure FPGAs and corresponding routing logic). These different collections of compiled data for each partition are then used to configure separate emulation systems to emulate the operations of the separate partitions of the full integrated circuit design. As noted above, the separate or independent compilation of the different circuit portions enables decoupling of the different circuit portions of the integrated circuit design, such that changes that are restricted to one partition of the integrated circuit design require only recompilation of that partition of the integrated circuit design and without recompiling other partitions of the integrated circuit design.

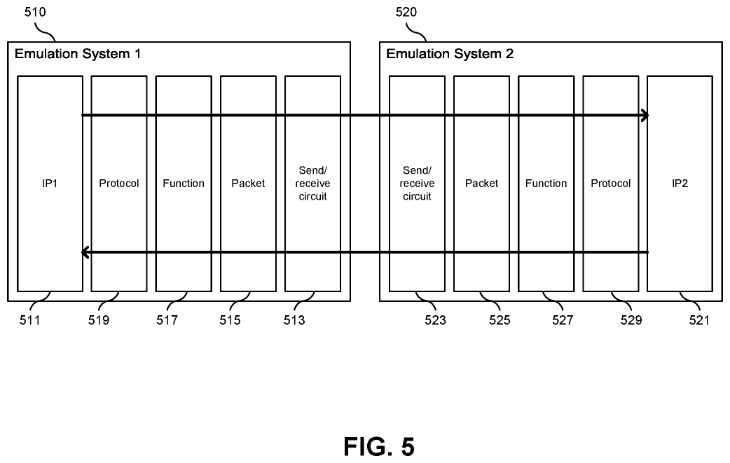

FIG. 5 depicts a layered view of the connection for emulation communication between two circuit modules or IP blocks emulated by different emulation systems (or different portions of an emulation system), where the connection is implemented using three layers of representation according to one embodiment of the present disclosure. As shown in FIG. 5, a first emulation system (Emulator 1) 510 emulates a first IP block 511 or first circuit module of the integrated circuit design and a second emulation system (Emulator 2) 520 emulates a second IP block 521 or second circuit module of the integrated circuit design. The emulation communication system of the first emulation system 510 includes three levels of representation above the underlying emulation communication circuit structure 513. As described above, these layers of representation include a packet level 515, a function level 517 (built on the packet level 515 representation), and a protocol level 519 (build on the function level 517 representation). Likewise, the emulation communication system of the second emulation system 520 includes three levels of representation above the underlying emulation communication circuit structure 523. These layers of representation include a packet level 525, a function level 527 (built on the packet level 525 representation), and a protocol level 529 (build on the function level 527 representation). Messages may then be exchanged between the emulated first IP block 511 and the emulated second IP block 521 through, for example, the protocol, function, and packet level representation layers, where the defined message packet is transmitted through a send circuit of one IP block (e.g., send/receive circuit 513) and received through a receive circuit of the other IP block (e.g., send/receive circuit 523). Depending on the level at which the user implemented the message exchange, the protocol and/or function levels of the representation layers can be omitted. For example, if the user merely implements the message exchange between the emulation systems at the function level, then the circuit structures for implementing the protocol levels 519 and 529 can be omitted from the compiled design.

As noted above, the send/receive circuit for each IP block is instantiated in the FPGAs of the emulation system and is parameterized (e.g., configurable) for the emulation environment in which the IP blocks or circuit modules of the integrated circuit design are emulated.

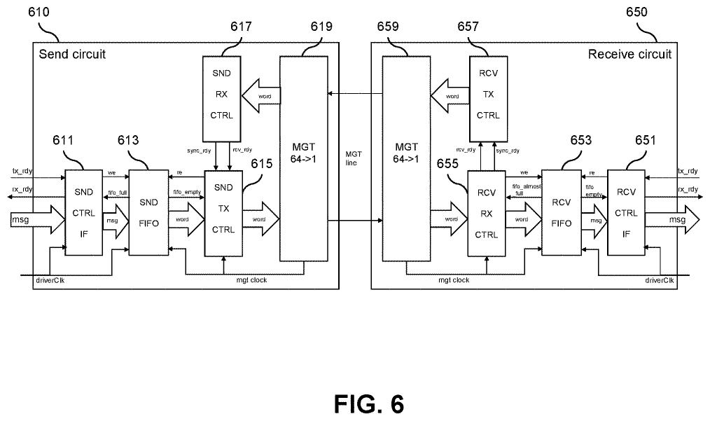

FIG. 6 is a block diagram illustrating a send circuit 610 and a receive circuit 650 inserted by an emulation compiler according to one embodiment of the present disclosure. The embodiments shown in FIG. 6 provide non-limiting examples of send/receive circuits that may be used, for example, as the send/receive circuit 513 and the send/receive circuit 523 shown in the embodiments according to FIG. 5, such as where the send/receive circuit 513 and the send/receive circuit 523 may each include a copy of the send circuit 610 and a copy of the receive circuit 650, such that each circuit can perform both send functionality and receive functionality. As noted above, the emulation compiler may insert send and receive circuits into the compiled data representing the circuit modules such that the FPGAs configured to emulate the corresponding circuit modules include send and receive circuits for exchanging data with circuit modules emulated on other FPGAs of the emulation system. For example, FIG. 6 may depict implementations of the zceiMessageOutPort module discussed above in Table 1 and the zceiMessageInPort module discussed above in Table 2. In some embodiments, the implementation of actual data transfer between the send and receive circuits is not visible to end user.

The example shown in FIG. 6 is implemented with a word size of 64 bits.

A packet in this example includes a 1 word (64 bit) header that includes a checksum (e.g., a cyclic redundancy check or CRC value), a packet type (e.g., IDLE or PAYLOAD), a packet control value, and a size N of a payload, in words (where N may be zero). The optional payload may include N words of data, in accordance with the size specified in the header of the packet.

A send control interface (SND CTRL IF) 611 is a hardware interface between an IP block or circuit module (DUT) (e.g., IP block 511 shown in FIG. 5) and a sender buffer (SND FIFO) 613. A driver clock domain (driverClock) accepts messages (msg) from the circuit module (DUT) as long as the sender buffer (SND FIFO) 613 is not full and the circuit module (DUT) is ready. The messages encode the stimuli output by the IP block or circuit module that are to be transmitted to another emulated IP block or circuit module of the integrated circuit design, where the other emulated IP block or circuit module is connected to the receive circuit 650.

The sender buffer (SND FIFO) 613 allows clock domain change between driverClock and multi-gigabit transceiver clock (mgt clock). Messages are written based on the driverClock domain, on MGT clock read side, data granularity is word (64-bits). The sender buffer (SND FIFO) 613 acts as a serializer.

The sender transmit controller (SND TX CTRL) 615 provides an interface between the sender buffer (SND FIFO), the sender receiver control (SND RX CTRL) 617 and the sender multi-gigabit transceiver (MGT) 619. The sender transmit controller 615 is configured to assemble packets to be sent to the multi-gigabit transceiver 619. When SND RX CRTL signal rcv_rdy is 1 and the sender buffer (SND FIFO) 613 is not empty, then CTRL WR reads data from the sender buffer (SND FIFO) 613 and sends the data packet to the MGT serializer. The send transmit controller 615 is also responsible of synchronization of the link at beginning of emulation.

The sender receive controller (SND RX CTRL) 617 provides an interface between the multi-gigabit transceiver (MGT) 619 at the sender circuit 610 and the sender transmit controller (SND TX CTRL) 615 and is configured to decode packets from the receiver transmit controller (RCV TX CTRL) 657.

The receiver receive controller (RCV RX CTRL) 655 is an interface between a receiver multi-gigabit transceiver (MGT) 659 at the receiver circuit 650, receiver transmit ready signal (RCV TX RDY), and receiver buffer (RCV FIFO) 653. When the receiver buffer (RCV FIFO) 653 is almost full (e.g., has space for exactly one more packet or K more packets, where K may be set based on parameters such as the latency and bandwidth of the emulation interconnect, such that the receiver buffer can store any additional packets that will be transmitted from the receiver before the sender circuit 610 receives a feedback signal or notification signal from the receiver circuit 650, discussed below), it signals to the receiver transmit controller (RCV TX CTRL) 655 using a rcv_rdy signal (e.g., setting rcv_rdy to false, as discussed in more detail below). The receiver receive controller (RCV RX CTRL) 655 also writes into the receiver buffer (RCV FIFO) 653 packets from the receiver multi-gigabit transceiver (MGT) 659 and ensures synchronization of the MGT 659.

The receiver buffer (RCV FIFO) 653 allows a clock domain change between the multi-gigabit transceiver (MGT) clock and the driverClock at the receiver circuit 650. This allows the receiver circuit 650 to accept messages on receiver side until the sender receives a notification that messages can no longer be read (e.g., because the receiver buffer 653 is full).

The receiver control interface (RCV CTRL IF) 651 provides an interface between the receiver buffer (RCV FIFO) 653, the receiver transmit controller (RCV TX CTRL) 657 and Serializer. The receiver control interface 651 also provides the received data to the circuit module (or IP block) connected to the receive circuit 650 in the form of the stimuli (msg) that was transmitted from the circuit module (or IP block) connected to the send circuit 610.

In some embodiments, the size of the receive buffer is set based on the latency of the communication link between the sender and the receiver. Here,
LS=Latency time for a packet from send IP to receive IP
LR=Latency time for a header from receive IP to send IP
RFS=RCV FIFO minimum size. RFS is equal to number of packets that can be sent during LR+LS

In some embodiments, when the receiver buffer (RCV FIFO) available space is nearly full (e.g., where the available space is greater than RFS but within a threshold of RFS), the receiver communicates that it is no longer ready to receive data, e.g., a receiver ready signal (rcv_rdy) may be set to false (rcv_rdy==0). The sender will continue sending packets until it receives a signal that rcv_rdy==0. The receiver buffer (RCV FIFO) has enough free space to accept the packets that will continue to arrive from sender after deassertion of the rcv_rdy.

As discussed above, some aspects of embodiments of the present disclosure relate to independent emulations of different partitions of the integrated circuit design using different emulation systems or different portions of an emulation system, each using an independent emulation clock. The partitioning of the integrated circuit design is performed at the level of different IP blocks communicating over an on-chip latency tolerant interconnect 108, such that the different partitions emulated by the different emulation systems or different portions of an emulation system are tolerant of latency in the stimuli or messages exchanged through the emulation communication circuit structures discussed above.

Accordingly, the one or more partitions emulated by a given emulation system or portion of an emulation system are independently emulated at an emulation clock rate that is not limited by the maximum emulation clock rate of other partitions that are emulated by other emulation systems (e.g., other computer systems) or by other portions of the emulation system (e.g., other boards of the emulation system) running at different emulation clock rates. This allows the separate partitions to be emulated at their highest clock rates, thereby enabling potential problems or bugs (e.g., timing violations, logical errors, and the like) to be detected within a given time budget for verifying an integrated circuit design.

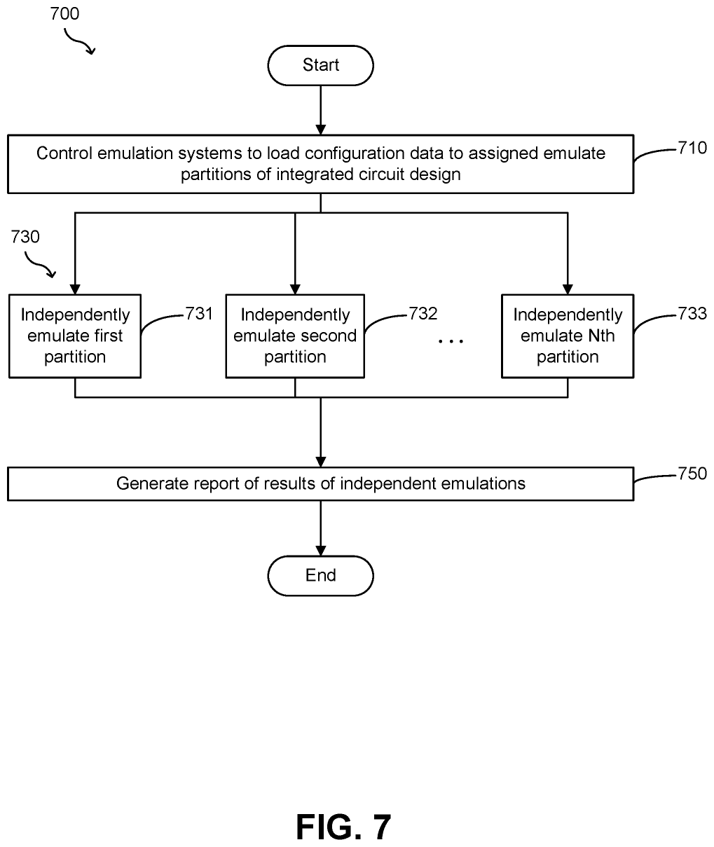

FIG. 7 is a flowchart of a method 700 for running a partitioned emulation of an integrated circuit design according to one embodiment of the present disclosure. At 710, a computer system managing the emulation of the integrated circuit design in an emulation environment controls a plurality of emulation systems (and/or a plurality of portions of emulation systems, according to various embodiments of the present disclosure) to load compiled configuration data for different partitions of the integrated circuit design (e.g., in accordance with the assignments of partitions to emulation systems that were made at 220 of FIG. 2). These compiled configuration data may be the data produced, for example, at 430 of the method 400 shown in FIG. 4, such that the configuration data for one partition includes one or more bitfiles for configuring one or more FPGAs to emulate a corresponding circuit portion (or IP block) of that partition of the integrated circuit design, and may also include information for how multiple FPGAs communicate with one another during emulation (e.g., for circuit paths that extend between FPGAs).

At 730, the computer system controls the emulation systems (or portions of emulation systems) to independently emulate respective assigned partitions of the integrated circuit design. During these independent emulations, the partitions may exchange messages or transmit stimuli with one another to emulate interactions between the IP blocks over a latency tolerant interconnect (e.g., the latency tolerant interconnect 108 shown in FIG. 1). FIG. 7 shows an example including a first independent emulation 731 to emulate first circuit portion or first IP block 101, a first independent emulation 732 to emulate second circuit portion or second IP block 102, and so on, to a third independent emulation 733 to emulate a Nth circuit portion or Nth IP block (e.g., sixth circuit portion or sixth IP block 106).

At 750, the computer system generates a report of the results of the independent emulations. This report may include, for example, the outputs computed by the circuit portions that were separately emulated, the values stored in memories or registers in the emulated partitions of the integrated circuit design over the course of the emulation, violations of timing conditions detected during the emulation of the integrated circuit design, differences between outputs of the emulated integrated circuit design and expected outputs, and the like.

As such, aspects of embodiments of the present disclosure relate to independent emulations of different partitions of an integrated circuit design, thereby enabling the different partitions of the integrated circuit design to be emulated at different emulation clock rates, where at least one of the partitions of the integrated circuit design is emulated at an emulation clock rate that is faster (higher clock rate) than the partition would have been emulated at if the entire integrated circuit design was emulated using a shared emulation clock.

Some aspects of embodiments of the present disclosure relate to emulating a single partition or a subset of the partitions of an integrated circuit design by replaying stimuli that was provided to the partition or subset of partitions by the partitions of the integrated circuit design that are not being emulated.

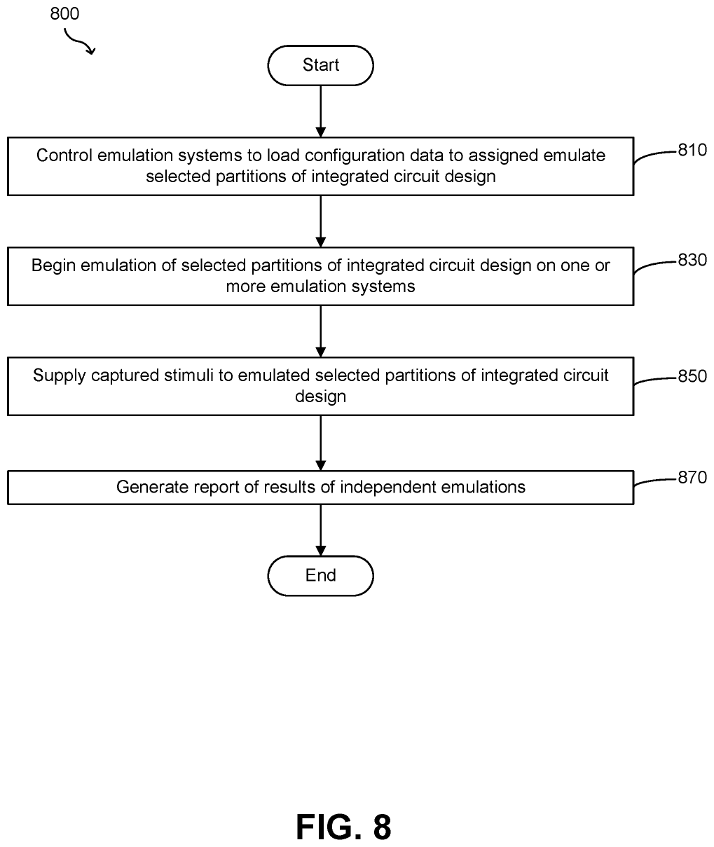

FIG. 8 is a flowchart of a method 800 for emulating a subset of the partitions of an integrated circuit design using a replay of stimuli from other partitions according to one embodiment of the present disclosure. At 810, a computer system controlling an emulation environment controls one or more emulation systems to load configuration data to emulate the selected partition or the selected subset of partitions of the integrated circuit design. In a manner similar to that described above, this may include loading one or more bitfiles for configuring FPGAs to emulate the selected partition or partitions of the integrated circuit design. At 830, the computer system loads the captured stimuli that were transmitted from other (unselected) partitions to the selected partition or selected partitions of the integrated circuit design. These captured stimuli may have been captured during an emulation run of the integrated circuit design where the selected partitions were emulated. As another example, these captured stimuli may have been captured during a simulation of the integrated circuit design. As still a third example, these captured stimuli may be generated based on expected behavior or expected stimuli to be transmitted to the selected partition or partitions.

At 830, the computer system controls the emulation environment to begin emulation of the selected partitions of the integrated circuit design using the configured one or more emulation systems. At 850, the computer system supplies the captured stimuli to the emulated selected partitions, such as by supplying the captured stimuli to the emulation communication circuit structures of the emulated circuit. As noted above, in some embodiments the captured stimuli are timestamped with the emulation clock cycle at which it was presented to the receiving circuit. Accordingly, in some embodiments, each captured stimulus among the captured stimuli includes a receiving partition (e.g., a corresponding receiving emulation communication circuit structure) and a timestamp (e.g., an emulation cycle number) as measured based on the independent emulation clock of the receiving partition. The computer system therefore supplies the stimulus to the appropriate emulation communication circuit structure when the independent emulation clock of the receiving partition matches the emulation timestamp specified in the stimulus.

At 870, the computer system generates a report of results of the emulation of the one or more selected partitions of the integrated circuit design. This report may include, for example, the outputs computed by the selected circuit portions that were emulated, the values stored in memories or registers in the selected emulated partitions of the integrated circuit design over the course of the emulation, violations of timing conditions detected during the emulation of the selected partitions of the integrated circuit design, differences between outputs of the emulated selected partitions of the integrated circuit design and expected outputs, and the like.

Accordingly, aspects of embodiments of the present disclosure relate to performing emulations of selected partitions or selected subsets of the full integrated circuit design, without emulating the full integrated circuit design, by replaying captured stimuli from the unselected partitions (or unemulated partitions of the integrated circuit design) to the selected emulated partitions.

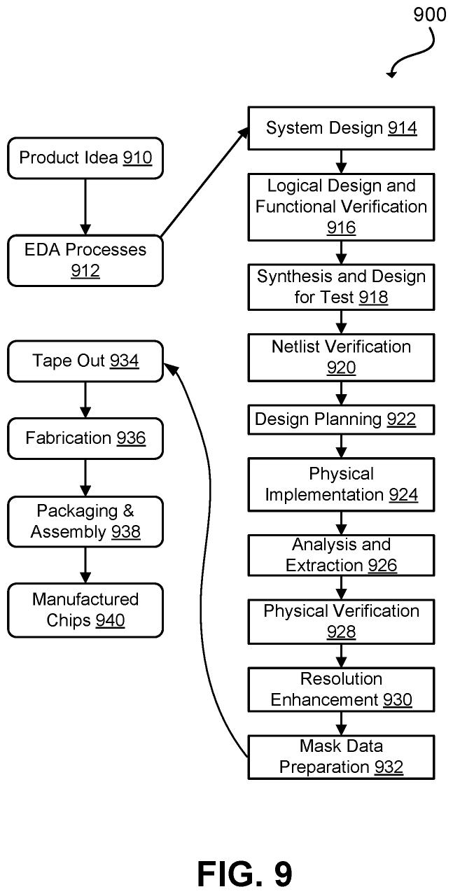

FIG. 9 illustrates an example set of processes 900 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 910 with information supplied by a designer, information which is transformed to create an article of manufacture that uses a set of EDA processes 912. When the design is finalized, the design is taped-out 934, which is when artwork (e.g., geometric patterns) for the integrated circuit is sent to a fabrication facility to manufacture the mask set, which is then used to manufacture the integrated circuit. After tape-out, a semiconductor die is fabricated 936 and packaging and assembly processes 938 are performed to produce the finished integrated circuit 940.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 9. The processes described by FIG. 9 may be enabled by EDA products (or EDA systems).

During system design 914, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 916, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 918, HDL code is transformed to a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 920, the netlist is checked for compliance with timing constraints and for correspondence with the HDL code. During design planning 922, an overall floor plan for the integrated circuit is constructed and analyzed for timing and top-level routing.

During layout or physical implementation 924, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as a module or component and are enabled as both physical structures and in simulations. Parameters are specified for selected cells (based on ‘standard cells’) such as size and made accessible in a database for use by EDA products.

During analysis and extraction 926, the circuit function is verified at the layout level, which permits refinement of the layout design. During physical verification 928, the layout design is checked to ensure that manufacturing constraints are correct, such as DRC constraints, electrical constraints, lithographic constraints, and that circuitry function matches the HDL design specification. During resolution enhancement 930, the geometry of the layout is transformed to improve how the circuit design is manufactured.

During tape-out, data is created to be used (after lithographic enhancements are applied if appropriate) for production of lithography masks. During mask data preparation 932, the ‘tape-out’ data is used to produce lithography masks that are used to produce finished integrated circuits.

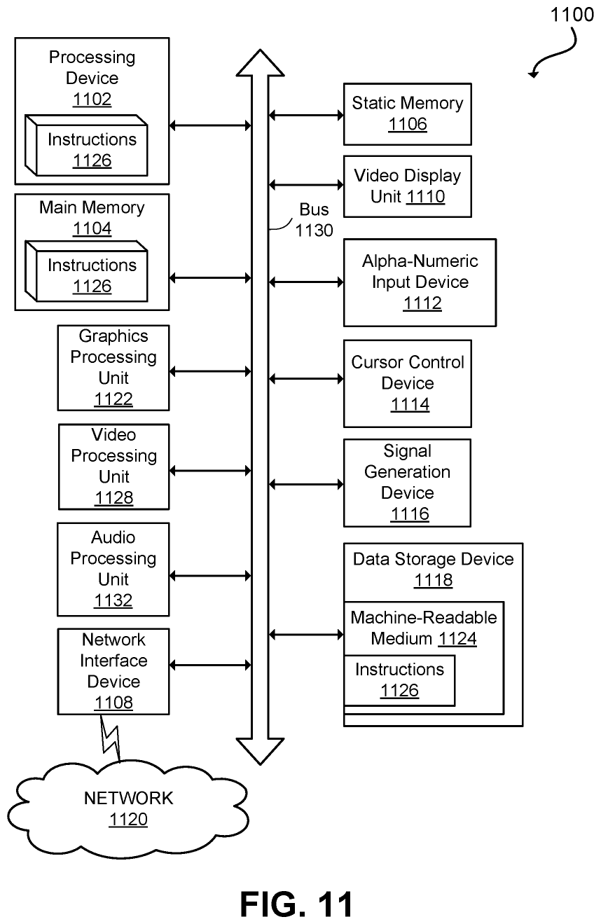

A storage subsystem of a computer system (such as computer system 1100 of FIG. 11, or host system 1007 of FIG. 10) may be used to store the programs and data structures that are used by some or all of the EDA products described herein, and products used for development of cells for the library and for physical and logical design that use the library.

FIG. 10 depicts a diagram of an example emulation environment 1000. An emulation environment 1000 may be configured to verify the functionality of the circuit design. The emulation environment 1000 may include a host system 1007 (e.g., a computer that is part of an EDA system) and an emulation system 1002 (e.g., a set of programmable devices such as Field Programmable Gate Arrays (FPGAs) or processors). The host system generates data and information by using a compiler 1010 to structure the emulation system to emulate a circuit design. A circuit design to be emulated is also referred to as a Design Under Test (‘DUT’) where data and information from the emulation are used to verify the functionality of the DUT.

The host system 1007 may include one or more processors. In the embodiment where the host system includes multiple processors, the functions described herein as being performed by the host system can be distributed among the multiple processors. The host system 1007 may include a compiler 1010 to transform specifications written in a description language that represents a DUT and to produce data (e.g., binary data) and information that is used to structure the emulation system 1002 to emulate the DUT. The compiler 1010 can transform, change, restructure, add new functions to, and/or control the timing of the DUT.

The host system 1007 and emulation system 1002 exchange data and information using signals carried by an emulation connection. The connection can be, but is not limited to, one or more electrical cables such as cables with pin structures compatible with the Recommended Standard 232 (RS232), universal serial bus (USB), or Peripheral Component Interconnect Express (PCIe or PCI Express) protocols. The connection can be a wired communication medium or network such as a local area network or a wide area network such as the Internet. The connection can be a wireless communication medium or a network with one or more points of access using a wireless protocol such as BLUETOOTH or IEEE 802.11. The host system 1007 and emulation system 1002 can exchange data and information through a third device such as a network server.

The emulation system 1002 includes multiple FPGAs (or other modules) such as FPGAs 1004₁ and 1004₂ as well as additional FPGAs to 1004_{N}. Each FPGA can include one or more FPGA interfaces through which the FPGA is connected to other FPGAs (and potentially other emulation components) for the FPGAs to exchange signals. An FPGA interface can be referred to as an input/output pin or an FPGA pad. While an emulator may include FPGAs, embodiments of emulators can include other types of logic blocks instead of, or along with, the FPGAs for emulating DUTs. For example, the emulation system 1002 can include custom FPGAs, specialized ASICs for emulation or prototyping, memories, and input/output devices.

A programmable device can include an array of programmable logic blocks and a hierarchy of interconnections that can enable the programmable logic blocks to be interconnected according to the descriptions in the HDL code. Each of the programmable logic blocks can enable complex combinational functions or enable logic gates such as AND, and XOR logic blocks. In some embodiments, the logic blocks also can include memory elements/devices, which can be simple latches, flip-flops, or other blocks of memory. Depending on the length of the interconnections between different logic blocks, signals can arrive at input terminals of the logic blocks at different times and thus may be temporarily stored in the memory elements/devices.

FPGAs 1004₁-1004_{N} may be placed onto one or more boards 1012₁ and 1012₂ as well as additional boards through 1012_{M}. Multiple boards can be placed into an emulation unit 1014₁. The boards within an emulation unit can be connected using the backplane of the emulation unit or any other types of connections. In addition, multiple emulation units (e.g., 1014₁ and 1014₂ through 1014_{K}) can be connected to each other by cables or any other means to form a multi-emulation unit system.

For a DUT that is to be emulated, the host system 1007 transmits one or more bit files to the emulation system 1002. The bit files may specify a description of the DUT and may further specify partitions of the DUT created by the host system 1007 with trace and injection logic, mappings of the partitions to the FPGAs of the emulator, and design constraints. Using the bit files, the emulator structures the FPGAs to perform the functions of the DUT. In some embodiments, one or more FPGAs of the emulators may have the trace and injection logic built into the silicon of the FPGA. In such an embodiment, the FPGAs may not be structured by the host system to emulate trace and injection logic.

The host system 1007 receives a description of a DUT that is to be emulated. In some embodiments, the DUT description is in a description language (e.g., a register transfer language (RTL)). In some embodiments, the DUT description is in netlist level files or a mix of netlist level files and HDL files. If part of the DUT description or the entire DUT description is in an HDL, then the host system can synthesize the DUT description to create a gate level netlist using the DUT description. A host system can use the netlist of the DUT to partition the DUT into multiple partitions where one or more of the partitions include trace and injection logic. The trace and injection logic traces interface signals that are exchanged via the interfaces of an FPGA. Additionally, the trace and injection logic can inject traced interface signals into the logic of the FPGA. The host system maps each partition to an FPGA of the emulator. In some embodiments, the trace and injection logic is included in select partitions for a group of FPGAs. The trace and injection logic can be built into one or more of the FPGAs of an emulator. The host system can synthesize multiplexers to be mapped into the FPGAs. The multiplexers can be used by the trace and injection logic to inject interface signals into the DUT logic.

The host system creates bit files describing each partition of the DUT and the mapping of the partitions to the FPGAs. For partitions in which trace and injection logic are included, the bit files also describe the logic that is included. The bit files can include place and route information and design constraints. The host system stores the bit files and information describing which FPGAs are to emulate each component of the DUT (e.g., to which FPGAs each component is mapped).

Upon request, the host system transmits the bit files to the emulator. The host system signals the emulator to start the emulation of the DUT. During emulation of the DUT or at the end of the emulation, the host system receives emulation results from the emulator through the emulation connection. Emulation results are data and information generated by the emulator during the emulation of the DUT which include interface signals and states of interface signals that have been traced by the trace and injection logic of each FPGA. The host system can store the emulation results and/or transmits the emulation results to another processing system.

After emulation of the DUT, a circuit designer can request to debug a component of the DUT. If such a request is made, the circuit designer can specify a time period of the emulation to debug. The host system identifies which FPGAs are emulating the component using the stored information. The host system retrieves stored interface signals associated with the time period and traced by the trace and injection logic of each identified FPGA. The host system signals the emulator to re-emulate the identified FPGAs. The host system transmits the retrieved interface signals to the emulator to re-emulate the component for the specified time period. The trace and injection logic of each identified FPGA injects its respective interface signals received from the host system into the logic of the DUT mapped to the FPGA. In case of multiple re-emulations of an FPGA, merging the results produces a full debug view.

The host system receives, from the emulation system, signals traced by logic of the identified FPGAs during the re-emulation of the component. The host system stores the signals received from the emulator. The signals traced during the re-emulation can have a higher sampling rate than the sampling rate during the initial emulation. For example, in the initial emulation a traced signal can include a saved state of the component every X milliseconds. However, in the re-emulation the traced signal can include a saved state every Y milliseconds where Y is less than X. If the circuit designer requests to view a waveform of a signal traced during the re-emulation, the host system can retrieve the stored signal and display a plot of the signal. For example, the host system can generate a waveform of the signal. Afterwards, the circuit designer can request to re-emulate the same component for a different time period or to re-emulate another component.

A host system 1007 and/or the compiler 1010 may include sub-systems such as, but not limited to, a design synthesizer sub-system, a mapping sub-system, a run time sub-system, a results sub-system, a debug sub-system, a waveform sub-system, and a storage sub-system. The sub-systems can be structured and enabled as individual or multiple modules or two or more may be structured as a module. Together these sub-systems structure the emulator and monitor the emulation results.

The design synthesizer sub-system transforms the HDL that is representing a DUT 1005 into gate level logic. For a DUT that is to be emulated, the design synthesizer sub-system receives a description of the DUT. If the description of the DUT is fully or partially in HDL (e.g., RTL or other level of representation), the design synthesizer sub-system synthesizes the HDL of the DUT to create a gate-level netlist with a description of the DUT in terms of gate level logic.

The mapping sub-system partitions DUTs and maps the partitions into emulator FPGAs. The mapping sub-system partitions a DUT at the gate level into a number of partitions using the netlist of the DUT. For each partition, the mapping sub-system retrieves a gate level description of the trace and injection logic and adds the logic to the partition. As described above, the trace and injection logic included in a partition is used to trace signals exchanged via the interfaces of an FPGA to which the partition is mapped (trace interface signals). The trace and injection logic can be added to the DUT prior to the partitioning. For example, the trace and injection logic can be added by the design synthesizer sub-system prior to or after the synthesizing the HDL of the DUT.

In addition to including the trace and injection logic, the mapping sub-system can include additional tracing logic in a partition to trace the states of certain DUT components that are not traced by the trace and injection. The mapping sub-system can include the additional tracing logic in the DUT prior to the partitioning or in partitions after the partitioning. The design synthesizer sub-system can include the additional tracing logic in an HDL description of the DUT prior to synthesizing the HDL description.

The mapping sub-system maps each partition of the DUT to an FPGA of the emulator. For partitioning and mapping, the mapping sub-system uses design rules, design constraints (e.g., timing or logic constraints), and information about the emulator. For components of the DUT, the mapping sub-system stores information in the storage sub-system describing which FPGAs are to emulate each component.

Using the partitioning and the mapping, the mapping sub-system generates one or more bit files that describe the created partitions and the mapping of logic to each FPGA of the emulator. The bit files can include additional information such as constraints of the DUT and routing information of connections between FPGAs and connections within each FPGA. The mapping sub-system can generate a bit file for each partition of the DUT and can store the bit file in the storage sub-system. Upon request from a circuit designer, the mapping sub-system transmits the bit files to the emulator, and the emulator can use the bit files to structure the FPGAs to emulate the DUT.

If the emulator includes specialized ASICs that include the trace and injection logic, the mapping sub-system can generate a specific structure that connects the specialized ASICs to the DUT. In some embodiments, the mapping sub-system can save the information of the traced/injected signal and where the information is stored on the specialized ASIC.

The run time sub-system controls emulations performed by the emulator. The run time sub-system can cause the emulator to start or stop executing an emulation. Additionally, the run time sub-system can provide input signals and data to the emulator. The input signals can be provided directly to the emulator through the connection or indirectly through other input signal devices. For example, the host system can control an input signal device to provide the input signals to the emulator. The input signal device can be, for example, a test board (directly or through cables), signal generator, another emulator, or another host system.

The results sub-system processes emulation results generated by the emulator. During emulation and/or after completing the emulation, the results sub-system receives emulation results from the emulator generated during the emulation. The emulation results include signals traced during the emulation. Specifically, the emulation results include interface signals traced by the trace and injection logic emulated by each FPGA and can include signals traced by additional logic included in the DUT. Each traced signal can span multiple cycles of the emulation. A traced signal includes multiple states and each state is associated with a time of the emulation. The results sub-system stores the traced signals in the storage sub-system. For each stored signal, the results sub-system can store information indicating which FPGA generated the traced signal.

The debug sub-system allows circuit designers to debug DUT components. After the emulator has emulated a DUT and the results sub-system has received the interface signals traced by the trace and injection logic during the emulation, a circuit designer can request to debug a component of the DUT by re-emulating the component for a specific time period. In a request to debug a component, the circuit designer identifies the component and indicates a time period of the emulation to debug. The circuit designer's request can include a sampling rate that indicates how often states of debugged components should be saved by logic that traces signals.

The debug sub-system identifies one or more FPGAs of the emulator that are emulating the component using the information stored by the mapping sub-system in the storage sub-system. For each identified FPGA, the debug sub-system retrieves, from the storage sub-system, interface signals traced by the trace and injection logic of the FPGA during the time period indicated by the circuit designer. For example, the debug sub-system retrieves states traced by the trace and injection logic that are associated with the time period.

The debug sub-system transmits the retrieved interface signals to the emulator. The debug sub-system instructs the debug sub-system to use the identified FPGAs and for the trace and injection logic of each identified FPGA to inject its respective traced signals into logic of the FPGA to re-emulate the component for the requested time period. The debug sub-system can further transmit the sampling rate provided by the circuit designer to the emulator so that the tracing logic traces states at the proper intervals.

To debug the component, the emulator can use the FPGAs to which the component has been mapped. Additionally, the re-emulation of the component can be performed at any point specified by the circuit designer.

For an identified FPGA, the debug sub-system can transmit instructions to the emulator to load multiple emulator FPGAs with the same configuration of the identified FPGA. The debug sub-system additionally signals the emulator to use the multiple FPGAs in parallel. Each FPGA from the multiple FPGAs is used with a different time window of the interface signals to generate a larger time window in a shorter amount of time. For example, the identified FPGA can require an hour or more to use a certain amount of cycles. However, if multiple FPGAs have the same data and structure of the identified FPGA and each of these FPGAs runs a subset of the cycles, the emulator can require a few minutes for the FPGAs to collectively use all the cycles.

A circuit designer can identify a hierarchy or a list of DUT signals to re-emulate. To enable this, the debug sub-system determines the FPGA needed to emulate the hierarchy or list of signals, retrieves the necessary interface signals, and transmits the retrieved interface signals to the emulator for re-emulation. Thus, a circuit designer can identify any element (e.g., component, device, or signal) of the DUT to debug/re-emulate.

The waveform sub-system generates waveforms using the traced signals. If a circuit designer requests to view a waveform of a signal traced during an emulation run, the host system retrieves the signal from the storage sub-system. The waveform sub-system displays a plot of the signal. For one or more signals, when the signals are received from the emulator, the waveform sub-system can automatically generate the plots of the signals.

FIG. 11 illustrates an example machine of a computer system 1100 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random-access memory (DRAM) such as synchronous DRAM (SDRAM), a static memory 1106 (e.g., flash memory, static random access memory (SRAM), etc.), and a data storage device 1118, which communicate with each other via a bus 1130.

Processing device 1102 represents one or more processors such as a microprocessor, a central processing unit, or the like. More particularly, the processing device may be complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 may be configured to execute instructions 1126 for performing the operations and steps described herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a non-transitory computer-readable medium) on which is stored one or more sets of instructions 1126 or software embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In some implementations, the instructions 1126 include instructions to implement functionality corresponding to the present disclosure. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 1102 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A method comprising:
receiving an integrated circuit design comprising a plurality of circuit modules;
partitioning the integrated circuit design into a plurality of partitions in accordance with the plurality of circuit modules;
assigning the plurality of partitions of the integrated circuit design to corresponding portions of an emulation system;
inserting, by a processor, a plurality of emulation communication circuit structures into the plurality of circuit modules of the integrated circuit design, the corresponding portions of the emulation system being configured to communicate via one or more emulation interconnects connected to the emulation communication circuit structures, the emulation communication circuit structures being represented at a representation level selected from a group comprising: a packet level; a transaction level; and a protocol level; and
emulating operation of the integrated circuit design using the emulation system.

2. The method of claim 1, wherein the portions of the emulation system comprise one or more components selected from a group comprising:
a field programmable gate array;
a board comprising a plurality of field programmable gate arrays; and
a computer system connected to a plurality of boards of field programmable gate arrays.

3. The method of claim 2, wherein the emulation interconnects comprise one or more interconnects selected from a group comprising:
a low-voltage differential signaling interconnect;
a multi-gigabit transceiver;
a backplane of an emulation unit; and
an Ethernet connection.

4. The method of claim 1, further comprising supplying the plurality of circuit modules separately to an emulation compiler to generate a plurality of compiled circuit modules.

5. The method of claim 4, wherein the emulation compiler is configured to compile an emulation communication circuit structure into a circuit module of the plurality of circuit modules, the emulation communication circuit structure being configured to communicate with another circuit module of the plurality of circuit modules via the one or more emulation interconnects.

6. The method of claim 1, further comprising:
capturing stimuli transmitted from a first partition of the plurality of partitions to a second partition of the plurality of partitions over the one or more emulation interconnects during emulation of the operation of the first partition and the second partition of the integrated circuit design; and
storing the stimuli as a plurality of captured stimuli in a stimuli store, a captured stimulus of the captured stimuli comprising an emulation timestamp based on an emulation clock of the emulation of the second partition.

7. The method of claim 6, further comprising:
configuring a portion of the emulation system to emulate the second partition; and
supplying the captured stimuli from the stimuli store to the second partition during emulation of the operation of the second partition using the emulation system without emulating the first partition.

8. The method of claim 1, wherein the emulating the operation of the integrated circuit design using the emulation system comprises:
emulating a first partition of the plurality of partitions comprising a first circuit module of the plurality of circuit modules using a first portion of the emulation system in accordance with a first emulation clock; and
emulating a second partition of the plurality of partitions comprising a second circuit module of the plurality of circuit modules using a second portion of the emulation system in accordance with a second emulation clock, the second emulation clock being independent of the first emulation clock.

9. A system comprising:
a first emulation system comprising a first plurality of field programmable gate arrays (FPGAs);
a second emulation system comprising one or more second plurality of FPGAs; and
a host system comprising a processor and memory storing instructions that, when executed, cause the processor to:
receive an integrated circuit design comprising a plurality of circuit modules configured to communicate via a latency tolerant interconnect;
partition the integrated circuit design into a plurality of partitions in accordance with the plurality of circuit modules;
insert a first emulation communication circuit structure into a first FPGA of the first plurality of FPGAs and a second emulation communication circuit structure into a second FPGA of the second plurality of FPGAs, the first emulation communication circuit structure and the second emulation communication circuit structure being represented at a representation level selected from a group comprising: a packet level; a transaction level; and a protocol level;
configure the first plurality of FPGAs of the first emulation system to emulate a first partition of the plurality of partitions of the integrated circuit design;
configure the second plurality of FPGAs of the second emulation system to emulate a second partition of the plurality of partitions of the integrated circuit design; and
emulate operation of the integrated circuit design using the first emulation system and the second emulation system, the first partition and the second partition being configured to communicate using the first emulation communication circuit structure and the second emulation communication circuit structure.

10. The system of claim 9, wherein the memory further stores instructions that, when executed, cause the processor to control a stimuli capture circuit to capture stimuli transmitted from the first partition emulated by the first emulation system to the second partition emulated by the second emulation system.

11. The system of claim 10, wherein the stimuli capture circuit is connected to an emulation interconnect between the first emulation system and the second emulation system.

12. The system of claim 10, wherein the stimuli capture circuit connected to an emulation communication circuit structure of the second emulation system.

13. The system of claim 9, wherein the first emulation system is configured to emulate the first partition at a first emulation clock rate, and
wherein the second emulation system is configured to emulate the second partition at a second emulation clock rate independent of the first emulation clock rate.

14. A non-transitory computer-readable medium comprising stored instructions, which when executed by a processor cause the processor to:
receive an integrated circuit design comprising a plurality of circuit modules configured to communicate via a latency tolerant interconnect;
partition the integrated circuit design into a plurality of partitions in accordance with the circuit modules;
insert a first emulation communication circuit structure into a first circuit module of a first partition of the plurality of partitions, the first emulation communication circuit structure being represented at a first representation level selected from a group comprising: a packet level; a transaction level; and a protocol level;
compile the first circuit module to generate a first compiled circuit module comprising a first bitfile to configure a first field programmable gate array (FPGA) to emulate a first portion of the first circuit module;
insert a second emulation communication circuit structure into a second circuit module of a second partition of the plurality of partitions, the second emulation communication circuit structure being represented at a second representation level selected from the group comprising: the packet level; the transaction level; and the protocol level; and
compile the second circuit module, independent of the first circuit module, to generate a second compiled circuit module comprising a second bitfile to configure a second FPGA to emulate a second portion of the second circuit module.

15. The non-transitory computer-readable medium of claim 14, wherein the first emulation communication circuit structure is connected to an output pin of the first circuit module and is configured to send a packet of data representing a signal at the output pin in accordance with a protocol, and
wherein the second emulation communication circuit structure is connected to an input pin of the second circuit module and is configured to receive the packet of data in accordance with the protocol and to supply the signal represented in the packet of data to the input pin.

16. The non-transitory computer-readable medium of claim 14, wherein the first emulation communication circuit structure and the second emulation communication circuit structure are represented at the protocol level.

17. The non-transitory computer-readable medium of claim 14, wherein the first emulation communication circuit structure and the second emulation communication circuit structure are represented at the transaction level.

18. The non-transitory computer-readable medium of claim 14, wherein the first emulation communication circuit structure and the second emulation communication circuit structure are represented at the packet level.

19. The non-transitory computer-readable medium of claim 14, further storing instructions that, when executed, cause the processor to:
receive an updated integrated circuit design, wherein the first circuit module in the updated integrated circuit design is replaced with an updated first circuit module and wherein the second circuit module is unchanged from the second circuit module of the integrated circuit design; and
compile the updated first circuit module to generate an updated first compiled circuit module comprising a first updated bitfile to configure the first FPGA to emulate a first portion of the updated first circuit module without recompiling the second circuit module.

20. The non-transitory computer-readable medium of claim 14, wherein the first compiled circuit module is controlled by a first emulation clock, and
wherein the second compiled circuit module is controlled by a second emulation clock independent of the first emulation clock.
